(19) United States
(12) Patent Application Publication
(10) Pub. No.: US 2026/0234421 A1
(43) Pub. Date: Aug. 13, 2026

(54) LITHIUM BATTERY ELECTRODE BINDERS

(71) Applicant: SYENSQO SPECIALTY POLYMERS ITALY S.p.A., Bollate (IT)

(72) Inventors: Luca Petrizza, Milano (IT); Ségolène Brusseau, Lyon (FR); Rosita Lissette Pena Cabrera, Bergamo (IT); Andrea Vittorio Oriani, Milano (IT)

(73) Assignee: SYENSQO SPECIALTY POLYMERS ITALY S.p.A., Bollate (IT)

(21) Appl. No.: 19/157,603

(22) PCT Filed: Feb. 16, 2024
(86) PCT No.: PCT/EP2024/053946

§ 371 Date: Aug. 18, 2025

(30) Foreign Application Priority Data
Feb. 17, 2023 (EP) 23305212.5

(51) Int. Cl. C09D 5/24; C08F 14/22; C08K 3/32; C09D 7/61; C09D 127/14; H01M 4/131; H01M 4/62

(52) U.S. Cl. CPC C09D 5/24; C08F 14/22; C09D 7/61; C09D 127/14; H01M 4/131; H01M 4/623; C08K 2003/328

(57) ABSTRACT

The present invention pertains to binder compositions comprising vinylidene fluoride polymers and to their use in the preparation of electrodes for secondary batteries.

### TECHNICAL FIELD

The present invention pertains to binder compositions comprising vinylidene fluoride polymers and to their use in the preparation of electrodes for secondary batteries.

### BACKGROUND ART

Electrochemical devices such as secondary batteries typically comprise a positive electrode, a negative electrode and an electrolyte.

The most critical component of a lithium ion secondary battery is the positive electrode (cathode) material, whose performance affects the overall performance of the lithium ion secondary battery. Various attempts are being made to provide cathode materials having low production costs and large energy capacity while maintaining high-temperature stability.

The conventional active materials at the positive electrode are generally of the LiMO₂ type, of the LiMPO₄ type, of the Li₂MPO₃F type, of the Li₂MSiO₄ type, where M is Co, Ni, Mn, Fe or a combination of these, of the LiMn₂O₄ type or of the S₈ type.

Among these materials, lithium iron phosphate (LiFePO₄ or LFP), having an olivine structure, has attracted attention as a potential cathode material for Li-ion battery due to a high theoretical capacity (170 mA h g⁻¹), high safety and economic benefits.

However, phosphate olivine materials have poor electrical conductivity and a low lithium ion diffusion coefficient. To address these problems, several approaches such as morphology control, surface coating of an additional layer, and use of conductive additives have been proposed.

Nano-sizing is a known way to improve LFP cathode rate performance by reducing the transfer length of Lithium ion. However, Binders with higher binding force are needed in order to maintain the binding level of cathode to an aluminium foil, since nano-sized LFP has much higher surface area. Moreover, the slurry viscosity of nano-sized LFP is very high and could easily physically gelled or viscosity build-up during storing.

The electrodes for lithium batteries are usually produced by mixing a binder with a powdery electrode active material.

Fluororesins such as vinylidene fluoride-based polymers have been used as binders for forming positive electrodes. In particular, polyvinylidene fluoride (PVDF) provides a good electrochemical stability and high adhesion to the electrode materials and to current collectors. PVDF is therefore a preferred binder material for electrode slurries.

US 2015/0280238 discloses a stable electrode binder dispersion for use in the preparation of LFP cathodes for lithium ion battery, said dispersion comprising a PVDF dispersed in an organic diluent and a (meth)acrylic polymer dispersant.

CN101752546 discloses a method for preparing a LFP electrode by using a binder compositions that includes HSV900 polyvinylidene fluoride, which is a commercially available PVDF homopolymer obtained by emulsion polymerization.

However, it is known that certain PVDF polymers when used in the preparation of a slurry for forming positive electrodes with LFP active material, have an important drawback, in that the slurry often undergoes to a rapid viscosity increase, leading to the formation of a gel, thus preventing their use as binder for LPF cathodes.

The present invention provides a positive electrode-forming composition comprising olivine active material capable of preventing gelation while, at the same time, enabling the manufacturing of electrodes having enhanced adhesion and electrochemical stability.

### SUMMARY OF INVENTION

It has been found that certain vinylidene fluoride polymers are endowed with very good adhesion to metal substrates and can be used in the preparation of electrode-forming compositions having improved slurry viscosity over time.

It is thus an object of the invention a positive electrode-forming composition (C) for use in the preparation of electrodes for electrochemical devices comprising:
a) at least one positive electrode active material (AM), wherein the active material (AM) is a phospho-olivine material having an average particle size of from 100 nm to 20 μm;
b) a VDF-based polymer [polymer (F)] having a molecular weight higher than 1000000 g·mol⁻¹ and lower than 2000000 g·mol⁻¹ determined by GPC using a conventional calibration with polystyrene, where the polymer (F) is characterized by being obtainable by a process comprising a step of radical polymerization with an organic radical initiator system, wherein said organic radical initiator system is not soluble in water;
c) at least one solvent (S); and
d) optionally, at least one electroconductivity-imparting additive.

In another object, the present invention pertains to the use of the electrode-forming composition (C) in a process for the manufacture of an electrode [electrode (E)], said process comprising:
(I) providing a metal substrate having at least one surface;
(II) providing an electrode-forming composition (C) as above defined;
(III) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (III);
(V) submitting the dried assembly obtained in step (IV) to a compression step to obtain the electrode (E) of the invention.

In a further object, the present invention pertains to the electrode (E) obtainable by the process of the invention.

In still a further object, the present invention pertains to an electrochemical device comprising at least one electrode (E) of the present invention.

### DETAILED DESCRIPTION

By the term “VDF-based polymer” it is intended to denote a VDF homopolymer (PVDF) and VDF-based copolymers including recurring units derived from VDF and recurring units derived from at least one fluorinated comonomer (CF), different from VDF.

The VDF-based polymer (F) of the present invention does not include any hydrogenated monomer bearing polar groups.

By the term “recurring unit derived from vinylidene fluoride” (also generally indicated as vinylidene difluoride 1,1-difluoroethylene, VDF), it is intended to denote a recurring unit of formula CF₂═CH₂.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).
(e) perfluoro(alkyl)vinyl ethers, such as perfluoro(methyl)vinyl ether (PMVE), perfluoro(ethyl) vinyl ether (PEVE) and perfluoro(propyl)vinyl ether (PPVE);
(f) perfluoro(1,3-dioxole); perfluoro(2,2-dimethyl-1,3-dioxole) (PDD).

In one preferred embodiment, polymer (F) is semi-crystalline and comprises from 0.1 to 20.0% by moles, preferably from 0.3 to 10.0% by moles, more preferably from 0.5 to 5.0% by moles of recurring units derived from said fluorinated comonomer (CF).

The polymer (F) can be an elastomer or a semi-crystalline polymer, preferably being a semi-crystalline polymer.

As used herein, the term “semi-crystalline” means a fluoropolymer that has, besides the glass transition temperature Tg, at least one crystalline melting point on DSC analysis. For the purposes of the present invention a semi-crystalline fluoropolymer is hereby intended to denote a fluoropolymer having a heat of fusion of from 10 to 90 J/g, preferably of from 30 to 80 J/g, more preferably of from 35 to 75 J/g, as measured according to ASTM D4591.

To the purpose of the invention, the term “elastomer” is intended to designate a true elastomer or a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

The polymer (F) of the present invention usually has a melting temperature (Tm) comprised in the range from 150 to 200° C.

The melting temperature may be determined from a DSC curve obtained by differential scanning calorimetry (hereinafter, also referred to as DSC). In the case where the DSC curve shows a plurality of melting peaks (endothermic peaks), the melting temperature (Tm) is determined on the basis of the peak having the largest peak area.

It is understood that defects or other impurity-type moieties might be comprised in the polymer (F) without these impairing its properties.

The polymer (F) preferably has a molecular weight higher than 1200000 g·mol-1 and lower than 1800000 g·mol-1, as determined by GPC using a conventional calibration with polystyrene, as detailed below.

The polymer (F) is characterized by being obtained by a polymerization process in the presence of an organic radical initiator system that is not soluble in water.

Polymer (F) may be obtained in particular by a process that comprises:
polymerizing the vinylidene fluoride (VDF) and optionally comonomer (CF), in an aqueous medium in the presence of an organic radical initiator system that is not soluble in water and of at least one suspending agent;
maintaining the pressure in said reactor vessel exceeding the critical pressure of the vinylidene fluoride;
maintaining the temperature in said reactor vessel above a temperature of 31° C. and at maximum of 70° C.

The term “initiator system” includes a single initiator, or a mixture of initiators, each of which is typically dissolved or suspended in a solvent (e.g., a hydrocarbon solvent) that is added to the polymerization process.

By the term “not soluble in water” it is intended to denote that the organic radical initiator system has a solubility in water less than 1 g/l.

Preferred water-insoluble initiator are water-insoluble peroxide initiators and water-insoluble peroxydicarbonates.

Examples of organic radical initiator systems for use in the preparation of the polymer (F) include: organic dialkyl peroxides such as, for example, di-t-butyl peroxide (DTBP), dialkyl peroxydicarbonates, such as diisopropyl-peroxydicarbonate (IPP), di-N-propyl-peroxydicarbonate (NPP), diethyl-peroxy dicarbonate, di-sec-butyl-peroxydicarbonate (DBP); t-alkylperoxybenzoates, such as tert-butyl or tert-amyl peroxypivalate.

In a preferred embodiment of the present invention, polymer (F) used in the composition (C) is obtained by a polymerization process in the presence of a t-alkylperoxybenzoate initiator, more preferably the initiator used is tert-amyl peroxypivalate.

The amount of radical initiator required for a polymerization is related to its activity and the temperature used for the polymerization. The total amount of radical initiator used is generally between 100 to 30000 ppm by, preferably between 400 and 1000 ppm by weight on the total monomers weight used.

The organic radical initiator may be added to the reaction mixture in pure form, in solution, in suspension, or in emulsion, depending upon the initiator chosen.

The organic radical initiator systems may include a chain transfer agent (CTA).

Suitable CTA for the polymerization process for preparing the polymer (F) for use in the present invention are those known in the art and are typically selected from the group consisting of short hydrocarbon chains like ethane and propane, alcohols such as ethanol, tert-butanol and isopropanol, esters such as ethyl acetate or diethyl maleate, diethylcarbonate.

When an organic peroxide is used as the initiator, it could act also as effective CTA during the course of free radical polymerization.

When used, the CTA may be added all at once at the beginning of the reaction, or it may be added in portions, or continuously throughout the course of the reaction. The amount of CTA and its mode of addition depend on the desired properties of polymer (F) to be obtained.

Preferred CTA for use in the process of the present invention is diethylcarbonate.

In the process for preparing the polymer (F), pressure is maintained above critical pressure of vinylidene fluoride. Generally, the pressure is maintained at a value of more than 50 bars, preferably of more than 75 bars, even more preferably of more than 100 bars.

The polymer (F) is typically provided in form of powder according to the process described above.

The polymer (F) typically has a particle size in the range comprised between 10 μm and 500 μm

The polymer (F) is typically characterized by a fraction of gels <3% determined in a solution of 0.25% wt/vol of polymer (F) in a solution of N,N-Dimethylacetamide (DMA) with 0.01N Lithium Bromide.

For the purpose of the present invention, the term “positive active material (AM)” is intended to denote a compound that is able to incorporate or insert into its structure and substantially release therefrom alkaline or alkaline-earth metal ions during the charging phase and the discharging phase of an electrochemical device. The compound (AM) is preferably able to incorporate or insert and release lithium ions.

The term “phospho-olivine material” includes compounds having the following formula:

LiₓA_{y}D_{z}PO₄,

wherein A is selected from the group consisting of Mn, Fe, Co, Ni and Cu; D is selected from the group consisting of Mg, Ca, Sr, Ba; x, y and z are numbers that satisfy the following relationships: 0.9<x<1.2, 0<y<1.5, 0≤z<1.5.

The A component is preferably Fe, Mn, and Ni, and particularly preferably Fe.

The D component is preferably Mg or Ca.

Examples of the compound having an olivine structure include lithium iron phosphate (LFP), lithium manganese iron phosphate (LMFP), and lithium manganese phosphate.

Further, as the positive electrode active material (AM), it is possible to use a material whose surface is partially or wholly covered with carbon in order to supplement the conductivity.

The amount of carbon coated is preferably 20 parts by weight or less, more preferably 10 parts by weight or less, still more preferably 5 parts by weight or less, based on 100 parts by weight of the positive electrode active material.

The compound having an olivine structure is present in composition (C) in an amount of 70% by mass or more, with respect to 100% by mass of the entire positive electrode active material (AM).

According to embodiment, the phospho-olivine material consists of lithium iron phosphate (LFP).

According to one embodiment, the phospho-olivine material consists of lithium-iron-manganese phosphate (LMFP).

According to one embodiment, the phospho-olivine material consists of a blend of LFP and LMFP, the blend ratio varying from 0% to 100% by weight of each component.

More preferably, it is 90% by mass or more, and most preferably, the positive electrode active material (AM) is composed only of a phospho-olivine material.

Most preferably, the positive electrode active material (AM) consists only of lithium iron phosphate (LFP) or of lithium manganese iron phosphate (LMFP).

Phospho-olivine active materials suitable for use in the electrodes of the present invention may have nanometric particle size, which means that the size is less than 2 μm, or micrometric particle size, which means particles means with size between 2 μm and 1 millimeter.

In one preferred embodiment of the present invention, the positive electrode composition of the present invention is a nano-sized phospho-olivine material, characterized by having nanometric particle size with an average particle size of 2 μm or less, in particular in the range comprised between 100 nm ad 2 μm.

The Applicant has surprisingly found that, thanks to the use of a polymer (F)] having a molecular weight higher than 1000000 g·mol-1 and lower than 2000000 g·mol-1 and being obtained by a polymerization process in the presence of an organic radical initiator system that is not soluble in water, the known issue of increased slurry viscosity of nano-sized LFP cathode slurry compositions can be avoided.

The solvent (S) may preferably be an organic polar one, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. These solvents may be used singly or in mixture of two or more species.

The electro-forming composition (C) of the invention may further optionally include at least one conductive agent.

Examples thereof may include: carbonaceous materials, such as carbon black, graphite fine powder carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

In another object, the present invention pertains to the use of the electrode-forming composition (C) for the manufacture of a positive electrode (E), said process comprising:
(I) providing a metal substrate having at least one surface;
(II) providing an electrode-forming composition (C) as above defined;
(Ill) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (Ill);
(V) submitting the dried assembly obtained in step (IV) to a compression step to obtain the electrode (E) of the invention.

In a further object, the present invention pertains to the electrode (E) obtainable by the process of the invention.

The Applicant has surprisingly found that the electrode (E) of the present invention shows outstanding adhesion of the binder to current collector.

The electrode (E) of the invention is thus particularly suitable for use in electrochemical devices, in particular in secondary batteries.

For the purpose of the present invention, the term “secondary battery” is intended to denote a rechargeable battery.

The secondary battery of the invention is preferably an alkaline or an alkaline-earth metal secondary battery.

The secondary battery of the invention is more preferably a Lithium-ion secondary battery.

In still a further object, the present invention pertains to an electrochemical device comprising at least one electrode (E) of the present invention.

The electrochemical device according to the present invention, being preferably a secondary battery, comprises:
a positive electrode and a negative electrode,
   wherein the positive electrode is the electrode (E) of the present invention.

An electrochemical device according to the present invention can be prepared by standard methods known to a person skilled in the art.

The invention will be now described with reference to the following examples, whose purpose is merely illustrative and not intended to limit the scope of the invention.

### EXPERIMENTAL PART

### Raw Materials

HSV900: PVDF homopolymer, obtained by emulsion polymerization, commercially available from Arkema.

Nano-LFP: LFP DY-3, D50 0.6-1.8 μm, commercially available from Dynamic.

Carbon nanotubes (CNT): multiwall carbon nanotube (MWCNT) in N-Methyl-2-pyrrolidone (NMP) solvent.

### Determination of Intrinsic Viscosity of Polymer (F)

Intrinsic viscosity (η) [dl/g] was measured using the following equation on the basis of dropping time, at 25° C., of a solution obtained by dissolving the polymer (F) in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, isp is the specific viscosity, i.e. ηᵣ−1, and Γ is an experimental factor, which for polymer (F) corresponds to 3.

### DSC Analysis

DSC analyses were carried out according to ASTM D4591 standard; the melting point relating to the second heating run (T_{f2}) was determined at a heating rate of 10° C./min.

### GPC Analysis

For the GPC analyses a 0.25% wt/vol solution was prepared by solubilizing the polymer (F) in N,N-Dimethylacetamide with 0.01N Lithium Bromide at 45° C. for at least two hours.

Then, the latter solution was poured in a steel centrifuge tube and stirred at 20000 rpm at 25° C. for at least one hour.

GPC analyses on the supernatant were then carried out at 45° C. with a degassed eluent phase composed of N,N-Dimethylacetamide with 0.01N Lithium Bromide. The refractive index detector, in association with a set of 4 columns with different porosity sizes, was used to separate the different molecular weights. A conventional 15-point calibration was used to determine the relative molecular weight of VDF-based polymer with polystyrene standards until more than 3 000 000 g/mol.

### Determination of Gel Content of Polymer (F)

For the determination of the gel content a 0.25% wt/vol solution was prepared by solubilizing the polymer (F) in N,N-Dimethylacetamide with 0.01N Lithium Bromide at 45° C.

Then, the latter solution was poured in a steel centrifuge tube and stirred at 20000 rpm at 25° C.

The supernatant was then removed, and the bottom of the steel tube containing the gel was placed in an oven at 150° C. for 48 hours.

After drying, the gel content was quantified as percentage of the difference in weight between the steel tube before and after centrifugation.

### Example 1: Preparation of Polymer L-1

In a 4 L reactor equipped with an impeller running at a speed of 650 rpm were introduced in sequence: 2425 g of demineralized water and 0.27 g of PEO (Alkox®-E45 from Alroko) per kg of total monomers and 0.33 g of hydroxypropyl methylcellulose (Methocel®-K100 from DuPont Nutrition Biosciences SAS) per kg of total monomers. The oxygen present in the reactor was removed with a sequence of vacuum and purge of nitrogen at a fixed temperature of 14° C. This sequence was repeated 3 times.

Then, 1.46 g of a solution of the initiator t-amylperpivalate (from United Initiators) in isododecane (75%) and 7.94 g of diethyl carbonate were introduced in the reactor.

Then, the stirring speed was brought to 880 rpm and 1062 g of VDF were added to the reactor. The reactor was then gradually heated until the set point temperature of 46° C. was reached. The pressure was kept constantly equal to 120 bars during the whole polymerization run by VDF. A total of 529 g of VDF were charged and no more VDF was charged. Then the reaction was stopped by degassing the suspension until reaching atmospheric pressure.

The polymer was then collected by filtration and suspended against clean water in a stirred tank. After the washing treatment, the polymer was dried in an oven at 65° C. overnight. 1184 g of dry powder were collected.

A polymer L-1 having an intrinsic viscosity of 0.41 I/g, a T_{f2} of 169.8° C., a weight average molecular weight (Mw) of 1 700 000 g·mol⁻¹, and a gel content <3% was obtained.

### Example 2 Comparative: Preparation of Polymer A

In a 801 reactor equipped with an impeller running at a speed of 250 rpm were introduced in sequence: 52.4 Kg of demineralized water and 0.4 g of hydroxypropyl methylcellulose (Methocel®-K100 GR from Dow) per kg of VDF. The oxygen present in the reactor was removed with a sequence of vacuum and purge of nitrogen at a fixed temperature of 20° C. This sequence was repeated 3 times.

Then, 41.38 g of a solution of the initiator t-amylperpivalate (from United Initiators) in isododecane (75%) and 250.02 g of diethyl carbonate were introduced in the reactor. Immediately after, the stirring speed was brought to 300 rpm and 22.99 kg of VDF were added to the reactor. The reactor was then gradually heated until the set point temperature of 52° C. was reached. The pressure was kept constantly equal to 120 bars during the whole polymerization run by VDF. A total of 11.49 kg of VDF were charged and no more VDF was charged. Then the temperature was brought to 65° C. and then after a total of 169 minutes the reaction was stopped by degassing the suspension until reaching atmospheric pressure.

The polymer was then collected by filtration and suspended against clean water in a stirred tank. After the washing treatment, the polymer was dried in an oven at 65° C. overnight. 29.94 kg of dry powder were collected.

Polymer A: A polymer having an intrinsic viscosity of 0.27 l/g, a T_{f2} of 169.3° C., a weight average molecular weight (Mw) of 871 000 g·mol-1, and a gel content <3% was obtained.

### Example 3 Comparative: Polymer B

HSV900, product made by emulsion process, available from ARKEMA having an intrinsic viscosity of 0.168 l/g, a T_{f2} of 162° C., a weight average molecular weight (Mw) of 613 000 g·mol-1, and a gel content of 54%, all the data being determined by the procedures detailed above.

General Preparation of the Electrodes with LFP Active Material

Positive electrodes having final composition of 95.75% by weight of LFP, 3.5% by weight of polymer L-1, A or B, 0.75% by weight of conductive additive were prepared as follows.

A first dispersion was prepared by pre-mixing for 10 minutes in a centrifugal mixer 34.3 g of an 8% by weight solution of a polymer L-1, A or B in NMP, 75.07 g of LFP, 14.7 g of CNT pre-dispersed in NMP at 4% by weight and 15.93 g of NMP.

The mixture was then mixed using a high speed butterfly type impeller at 1500 rpm for 50 minutes. Additional 5.2 g of NMP were subsequently added to the dispersion, which was further mixed with a centrifugal mixer for 5 min. Positive electrodes were obtained by casting the obtained compositions on 15 μm thick Al foil with doctor blade and drying the as coated layers in a vacuum oven at temperature of 90° C. for about 50 minutes. The thickness of the dried coating layers was about 100 μm.

### Slurry Viscosity Measurement

The slurry viscosity was measured with an AntonPaar Rheolab QC using a Concentric cylinder setup (Measuring Cup: C-CC27/QC-LTD Bob: CC27/P6) with Peltier temperature control at 25° C. Steady state viscosities were measured from shear rate of 0.1 to 1000 1/s.

### Adhesion Measurement

### Adhesion Peeling Force Between Aluminum Foil and Electrode:

90° peeling tests were performed following the setup described in the standard ASTM D6862 at a speed of 300 mm/min at 20° C. in order to evaluate the adhesion of the dried coating layer to the Al foil.

### Adhesion and Slurry Viscosity

The polymers of examples 1 to 3 have been used as binders and the electrode compositions have been produced according to the procedure shown above. The values of slurry viscosity and adhesion are shown in Table 1.

TABLE 1

| | | Adhesion | Slurry viscosity at fix |
|---|---|---|---|
| Polymer | IV [l/g] | [N/m] | shear rate 5.6 Hz/mPa*s |
| L-1 | 0.409 | 8.73 | 4528 ± 129 |
| A | 0.271 | 5.82 | 1973 ± 169 |
| B | 0.168 | 10.1 | 4203 ± 355 |

The results show that the polymers of the present invention are more performing thanks to an improved adhesion to the current collector in comparison with polymer A.

### Slurry Gelation Measurement

The slurry viscosity over time was measured with an AntonPaar MCR92 using smooth parallel plates setup with a diameter of 50 mm (Measuring Plate: PP50) with Peltier temperature control at 25° C. Frequency sweep test was performed in the range of 0.1 to 100 rad/s with constant strain (0.5%) at different times to evidence the trend of viscosity by time.

The polymers of examples 1 to 3 were used as binders and the relative increment of their slurry viscosity was measured according to the procedure shown above. The values of the relative slurry viscosity increment over time are shown in Table 2.

TABLE 2

| | Slurry gelation | | | |
|---|---|---|---|---|
| | Relative Slurry viscosity increment at fix frequency 10 rad/s/a.u. | | | |
| Polymer | Time 0 h | Time 24 h | Time 48 h | Time 72 h |
| L-1 | 1.00 ± 0.02 | 1.05 ± 0.03 | 1.09 ± 0.07 | 1.15 ± 0.02 |
| A | 1.00 ± 0.00 | 1.13 ± 0.03 | 1.19 ± 0.07 | 1.20 ± 0.08 |
| B | 1.00 ± 0.05 | 1.72 ± 0.18 | 1.92 ± 0.23 | 2.10 ± 0.21 |

The results show that the polymers of the present invention show excellent slurry stability over time, i.e. comparable to polymer A and significantly better compared to polymer B.

1. A positive electrode-forming composition (C) for use in the preparation of electrodes for electrochemical devices, said composition (C) comprising:
a) at least one positive electrode active material (AM), wherein the active material (AM) is a phospho-olivine material having a D50 average particle size of from 100 nm to 20 μm;
b) a VDF-based polymer, polymer (F), having a molecular weight higher than 1000000 g·mol⁻¹ and lower than 2000000 g·mol⁻¹, wherein the molecular weight of polymer (F) is measured by GPC using a conventional calibration with polystyrene,
wherein the polymer (F) is obtained by a process comprising a step of radical polymerization with an organic radical initiator system, wherein said organic radical initiator system is not soluble in water;
c) at least one solvent (S); and
d) optionally, at least one electroconductivity-imparting additive.

2. The composition (C) according to claim 1, wherein polymer (F) is a VDF homopolymer.

3. The composition (C) according to claim 1, wherein polymer (F) is a VDF-based copolymer comprising recurring units derived from VDF and recurring units derived from at least one fluorinated comonomer (CF), different from VDF.

4. The composition (C) according to claim 3, wherein the fluorinated comonomer (CF) is selected from the group consisting of:
(a) C₂-C₈ fluoro- and/or perfluoroolefins;
(b) C₂-C₈ hydrogenated monofluoroolefins;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins;
(e) perfluoro(alkyl)vinyl ethers; and
(f) perfluoro(1,3-dioxole); perfluoro(2,2-dimethyl-1,3-dioxole) (PDD).

5. The composition (C) according to claim 1, wherein polymer (F) has a molecular weight higher than 1200000 g·mol-1 and lower than 1800000 g·mol-1, as determined by GPC using a conventional calibration with polystyrene.

6. The composition (C) according to claim 1, wherein the polymer (F) is obtained by a process comprising radical polymerization with an organic radical initiator system that is selected from the group consisting of: organic dialkyl peroxides, dialkyl peroxydicarbonates, di-N-propyl-peroxydicarbonate (NPP), diethyl-peroxy dicarbonate, di-sec-butyl-peroxydicarbonate (DBP); and t-alkylperoxybenzoates.

7. The composition (C) according to claim 1, wherein the active material (AM) is a phospho-olivine material of formula:
LiₓA_{y}D_{z}PO₄,
wherein A is selected from the group consisting of Mn, Fe, Co, Ni and Cu; D is selected from the group consisting of Mg, Ca, Sr, Ba; x, y and z are numbers that satisfy the following relationships: 0.9<x<1.2, 0<y<1.5, 0≤z<1.5.

8. The composition (C) according to claim 7, wherein the active material (AM) is selected from the group consisting of lithium iron phosphate (LFP), lithium manganese iron phosphate (LMFP), and lithium manganese phosphate.

9. The composition (C) according to claim 7, wherein the active material (AM) has a D50 average particle size in the range comprised between 100 nm and 2 μm.

10. A process for the manufacture of an electrode electrode (E), said process comprising:
(I) providing a metal substrate having at least one surface;
(II) providing an electrode-forming composition (C) according to claim 1;
(III) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (III);
(V) submitting the dried assembly obtained in step (IV) to a compression step to obtain the electrode (E) of the invention.

11. An electrode (E) obtained by the process of claim 10.

12. An electrochemical device comprising at least one electrode (E) according to claim 11.

13. The composition (C) according to claim 3, wherein the fluorinated comonomer (CF) is selected from the group consisting of:
(a) C₂-C₈ fluoro- and/or perfluoroolefins selected from the group consisting of tetrafluoroethylene (TFE), hexafluoropropylene (HFP), pentafluoropropylene and hexafluoroisobutylene;
(b) C₂-C₈ hydrogenated monofluoroolefins selected from the group consisting of vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins selected from the group consisting of chlorotrifluoroethylene (CTFE);
(e) perfluoro(alkyl)vinyl ethers selected from the group consisting of perfluoro(methyl)vinyl ether (PMVE), perfluoro(ethyl) vinyl ether (PEVE) and perfluoro(propyl)vinyl ether (PPVE); and
(f) perfluoro(1,3-dioxole); perfluoro(2,2-dimethyl-1,3-dioxole) (PDD).

14. The composition (C) according to claim 1, wherein the polymer (F) is obtained by a process comprising radical polymerization with an organic radical initiator system that is selected from the group consisting of: organic dialkyl peroxides selected from the group consisting of di-t-butyl peroxide (DTBP); dialkyl peroxydicarbonates selected from the group consisting of diisopropyl-peroxy dicarbonate (IPP), di-N-propyl-peroxydicarbonate (NPP), diethyl-peroxy dicarbonate, and di-sec-butyl-peroxydicarbonate (DBP); and t-alkylperoxybenzoates selected from the group consisting of tert-butyl peroxypivalate and tert-amyl peroxypivalate.

15. The composition (C) according to claim 1, wherein the active material (AM) has a D50 average particle size in the range comprised between 100 nm and 2 μm.
